(19) United States
(12) Patent Application Publication
(10) Pub. No.: US 2012/0028037 A1
(43) Pub. Date: Feb. 2, 2012

(54) COMPOSITION AND LAMINATE

(75) Inventor: Shuzo Tomizawa, Saitama (JP)

(73) Assignee: KIMOTO CO., LTD., Tokyo (JP)

(21) Appl. No.: 13/260,367

(22) PCT Filed: Mar. 2, 2010
(86) PCT No.: PCT/JP2010/053334

§ 371 Date: Sep. 25, 2011

(30) Foreign Application Priority Data
Mar. 30, 2009 (JP) 2009-081260

(51) Int. Cl. B32B 27/30; C09D 133/14; B32B 27/20; C09D 135/02

(52) U.S. Cl. 428/336; 524/523

(57) ABSTRACT

Provided are a composition, with which a coating film including an ionizing radiation curable resin and metal oxide particles can be formed, wherein surface hardness is not decreased to be lower than surface hardness in the case where a composition includes only an ionizing radiation curable resin, and a laminate. An exemplary composition can include an ionizing radiation curable resin, metal oxide particles and a polyfunctional (meth)acrylate having a multi-branched structure. A laminate can be formed on a substrate and provided with a coating film made by the composition that includes an ionizing radiation curable resin, metal oxide particles and a polyfunctional (meth)acrylate having a multi-branched structure.

This application is a U.S. national phase filing under 35 U.S.C. §371 of PCT Application No. PCT/JP2010/053334, filed Mar. 2, 2010, and claims priority under 35 U.S.C. §119 to Japanese patent application no. 2009-081260, filed Mar. 30, 2009, the entireties of both of which are incorporated herein by reference.

### TECHNICAL FIELD

The presently disclosed subject matter relates to a composition for forming a coating film and a laminate having a coating film, in particular, relates to a composition capable of forming a coating film having excellent surface hardness while providing an additional function to the coating film, and a laminate using the same.

### BACKGROUND ART

As a coating film having excellent surface hardness, those using curable resins are known. Among the curable resins, those using ionizing radiation-curable type are excellent particularly in surface hardness and widely used.

Also, a method of adding metal oxide particles to a curable resin so as to add a new function to a coating film is known.

However, in a coating film wherein metal oxide particles are included in a curable resin, bonding on an interface between the metal oxide particles and curable resin cannot be attained. Therefore, even when an ionizing radiation-curable resin was used as a curable resin, it had been hard not to decrease surface hardness and ended up in decreasing surface hardness.

To solve a problem as above, it's been thought to use a coupling agent as a dispersant for bonding metal oxide particles and an ionizing radiation curable resin (Patent Document 1).

### PRIOR ART REFERENCE

### Patent Document

Patent Document 1: Japanese Patent Unexamined Publication (Kokai) No. 2006-154187 (Claim 1)

### SUMMARY

However, uniform surface modification using a coupling agent on metal oxide particles, metal oxide nano-particles in particular, widely differs depending on control of pH and temperature of a solution. Therefore, some problems arise that it is difficult to control the surface modification and to maintain dispersion stability, etc. Even though the surface modification can be controlled and dispersion stability can be maintained, there arose a problem, such that the surface hardness decreased as a result.

An aspect of the presently disclosed subject matter, therefore, is to provide a composition, with which it is possible to form a coating film comprising an ionizing radiation curable resin and metal oxide particles capable of adding a new function, wherein surface hardness is not decreased to be lower than that of a coating film comprising only an ionizing radiation curable resin, and to provide a laminate using the composition.

The present inventors had studied the mechanism that surface hardness of a coating film obtained by a composition, wherein metal oxide particles and an ionizing radiation curable resin are blended with a general coupling agent, was decreased comparing with that of a coating film comprising only an ionizing radiation curable resin. As a result, they found that the added general coupling agent could not modify surfaces of the metal oxide particles completely and became detached from the particle surfaces, and the detached coupling agent hindered polymerization of the ionizing radiation curable resin and that led to lower a crosslink density, consequently, surface hardness of a coating film to be obtained was decreased. As a result that they furthermore pursued studying and devoted themselves to solve the problem above, they came to solve it by using a specific dispersant.

Namely, a composition of the presently disclosed subject matter comprises an ionizing radiation curable resin, metal oxide particles and a polyfunctional (meth)acrylate having a multi-branched structure.

The polyfunctional (meth)acrylate can have a multi-branched structure has a carboxyl group, amino group, carbonyl group, acrylic group or methacrylic group.

The polyfunctional (meth)acrylate can have a multi-branched structure has a dendrimer structure, hyper-branch structure or star-polymer structure, each having a number of branch structures.

The polyfunctional (meth)acrylate can have a multi-branched structure includes an ethylene oxide group and has a (meth)acrylate-functional group at the terminal.

The number of (meth)acrylate functional-groups of the polyfunctional (meth)acrylate having a multi-branched structure can be 3 to 10.

The polyfunctional (meth)acrylate having a multi-branched structure can have weight-average molecular weight of 500 to 30000.

The polyfunctional (meth)acrylate having a multi-branched structure can be included by an amount of 5 to 20% by weight of a total solid content of the composition.

The ionizing radiation curable resin can include at least one of linear (meth)acrylate oligomers, (meth)acrylic-type monomers and polythiol monomers. The ionizing radiation curable resin can also include at least a polythiol monomer.

The ionizing radiation curable resin can be included by an amount of 40 to 80% by weight of a total solid content of the composition.

The metal oxide particles can have a median diameter of 5 nm to 15 μm in a dispersion liquid measured by a dynamic scattering method.

The metal oxide particles can be included by an amount of 10 to 50% by weight of a total solid content of the composition.

Also, a laminate of the disclosed subject matter can be provided with a coating film formed on a substrate by a composition comprising an ionizing radiation curable resin, metal oxide particles and a polyfunctional (meth)acrylate having a multi-branched structure.

The coating film can be formed to have a thickness of 3 to 20 μm.

As explained above, when using a polyfunctional (meth)acrylate having a multi-branched structure as a dispersant, polymerization of an ionizing radiation curable resin is not hindered and a density of an acrylic group on metal oxide particle surfaces can be high. Also, by using a polyfunctional (meth)acrylate having a multi-branched structure as a dispersant, compatibility between an ionizing radiation curable resin and metal oxide particles is enhanced and it becomes possible to mix the metal oxide particles with the ionizing radiation curable resin while maintaining a degree of dispersion stable.

Also, a polyfunctional (meth)acrylate having a multi-branched structure brings gradient functionality between metal oxide particles and an ionizing radiation curable resin, and a curing shrinkage difference can be reduced, so that a decrease of surface hardness and deterioration from an interfacial surface of metal oxide particles can be reduced.

A composition of the presently disclosed subject matter can be made into a coating film comprising an ionizing radiation curable resin and metal oxide particles, which can add a new function, and having surface hardness not to be lower than that of a coating film comprising only an ionizing radiation curable resin.

Also, with a laminate of the presently disclosed subject matter, it is possible to provide a coating film comprising an ionizing radiation curable resin and metal oxide particles, which can add a new function, and having surface hardness not to be lower than that of a coating film comprising only an ionizing radiation curable resin.

Exemplary embodiments of a composition of the presently disclosed subject matter will be explained. A composition of the presently disclosed subject matter comprises an ionizing radiation curable resin, metal oxide particles and a polyfunctional (meth)acrylate having a multi-branched structure (hereinafter, also referred to as “a multi-branched polyfunctional (meth)acrylate”.

An ionizing radiation curable resin constituting the composition of an embodiment of the presently disclosed subject matter is those which can be crosslinked and cured at least by being irradiated with an ionic radiation (an ultraviolet ray or electron beam). As such an ionizing radiation curable resin, photo-cationic polymerizable resins, photo-radical polymerizable photo-polymerizable prepolymers or photo-polymerizable monomers may be used alone, or two or more kinds may be mixed for use.

Particularly, those having unsaturated double bond can be beneficial because a reaction with a polyfunctional (meth)acrylate having a multi-branched structure can become favorable, which will be explained later on. As an ionizing radiation curable resin having unsaturated double bond, those excepting for multi-branched polyfunctional (meth)acrylates, for example, linear (meth)acrylate oligomers, (meth)acrylic monomers and polythiol monomers, etc. may be used.

As (meth)acrylate oligomers, ester (meth)acrylate, ether (meth)acrylate, urethane (meth)acrylate, epoxy (meth)acrylate, amino resin (meth)acrylate, acrylic resin (meth)acrylate, melamine (meth)acrylate, polyfluoroalkyl (meth)acrylate, silicone (meth)acrylate, etc. may be used. These (meth)acrylate oligomers may be used alone, or two or more kinds may be mixed for use to give a variety of features of adjusting surface hardness or curing shrinkage, etc. of a coating film.

As (meth)acrylic monomers, 1,6-hexanediol di(meth)acrylate, neopentyl glycol di(meth)acrylate, diethylene glycol di(meth)acrylate, polyethylene glycol di(meth)acrylate, hydroxypivalic acid ester neopentyl glycol di(meth)acrylate and other bifunctional (meth)acrylic monomers; dipentaerithritol hexa(meth)acrylate, trimethylpropane tri(meth)acrylate, pentaerithritol tri(meth)acrylate and other polyfunctional (meth)acrylic monomers may be used alone or in combination of two or more kinds.

As polythiol monomers, trimethylolpropane tris-3-mercaptopropionate, pentaerithritol tetrakis-3-mercaptopropionate, dipentaerithritol hexa-3-mercaptopropionate, tris-(ethyl-3-mercaptopropionate)isocyanurate, etc. may be used. These polythiol monomers may be used alone, or two or three kinds may be mixed for use.

In the present embodiment, as an ionizing radiation curable resin having unsaturated double bond, it is sometimes preferable to include a polythiol monomer for use. When made into a coating film, polythiol monomers can reduce curing shrinkage of the coating film comparing with that in the cases of linear (meth)acrylate oligomers and (meth)acrylic monomers. As a result, it is possible to furthermore contribute to prevention of a decrease of surface hardness of a coating film when comprising metal oxide particles. Namely, it is possible to use an ionizing radiation curable resin comprising a polythiol monomer in terms of being furthermore contributable to prevention of a decrease of surface hardness of a coating film when comprising metal oxide particles.

A polythiol monomer can be 10% or less in an ionizing radiation curable resin. The reason why it is set to be 10% or less is to make it harder to decrease the surface hardness.

Note that, in the presently disclosed subject matter, a decrease of surface hardness of a coating film in the case of comprising metal oxide particles can be prevented even when using as an ionizing radiation curable resin acrylate-type oligomers or monomers, with which curing shrinkage becomes relatively large when made into a coating film; and the presently disclosed subject matter naturally includes embodiments wherein an ionizing radiation curable resin does not comprise any polythiol monomer and consists only of linear (meth)acrylate oligomer or (meth)acrylic monomer.

An ionizing radiation curable resin can be included in an amount of 40 to 80% by weight of a total solid content of a composition. When 40% by weight or more, a decrease of surface hardness of a coating film can be prevented more, and when 80% by weight or less, a function can be added from a metal oxide to the coating film.

Also, when a composition according to the presently disclosed subject matter is irradiating with an ultraviolet ray for curing for use, it is possible to use additives, such as a photopolymerization initiator and photopolymerization accelerator, in addition to (meth)acrylate oligomers and (meth)acrylic monomers.

As a photopolymerization initiator, acetophenone, benzophenone, Michiler's ketone, benzoin, benzylmethylketal, benzoylbenzoate, α-acyloxime ester and thioxanthones, etc. may be mentioned.

Also, a photopolymerization accelerator is those capable of reducing hindrance to polymerization due to the air during curing and accelerating a curing speed and, for example, p-dimethylaminobenzoic acid isoamyl ester and p-dimethylaminobenzoic acid ethyl ester, etc. may be mentioned.

Metal oxide particles are, by being added to a composition, for giving a function belonging to the metal oxide particles to a coating film. As the metal oxide particles, a titanium oxide, zinc oxide, zirconium oxide, tin oxide, aluminum oxide, cobalt oxide, magnesium oxide, iron oxide, silicon oxide, cerium oxide, indium oxide, barium titanate, clay; and those obtained by doping a lattice of these nano-particles with a different kind of metal, or those finished with surface modification, etc. may be used. Among them, a titanium oxide, zinc oxide, zirconium oxide, tin oxide and silicon oxide are beneficial because they have a hydroxyl group much on their particle surfaces and a multi-branched polyfunctional (meth)acrylate, which will be explained later on, can relatively easily be absorbed to the particle surfaces. As such metal oxide particles, those produced by a gas phase method or liquid phase method or, in accordance with need, those obtained by being fired and made into microcrystal may be also used.

As metal oxide particles, those having a specific surface area diameter of 2 nm to 10 μm may be used.

Also, metal oxide particles having a median diameter in a range of 5 nm to 15 μm in a dispersion liquid measured by a dynamic scattering method may be used, possibly in a range of the lower limit of 10 nm or larger, and in a range of the upper limit of 300 nm or smaller, possibly 100 nm or smaller and further possibly 50 nm or smaller.

When the median diameter in a dispersion liquid is 5 nm or larger, dispersion stability can be obtained. When the median diameter in a dispersion liquid is 15 μm or smaller, protrusion of metal oxide particles on the coating film surface can be reduced and a decline of transparency due to external haze can be prevented. Also, when using metal oxide particles of 300 nm or smaller, when in the form of a dispersion liquid, it becomes unnecessary to make viscosity of the dispersion liquid high to prevent deposition of the metal oxide particles and, in the case of bead mill dispersion, the situation that it becomes hard to separate beads and dispersion liquid can be prevented.

By using metal oxide particles having a relatively small median diameter of 100 nm or smaller in a dispersion liquid and adjusting a refractive index difference between an ionizing radiation curable resin and metal oxide particles, a decline of transparency due to internal haze can be prevented. Furthermore, by using metal oxide particles having a small median diameter of 50 nm or smaller in a dispersion liquid, scattering lights by metal oxide particles can be reduced, so that a coating film having excellent transparency can be obtained.

Metal oxide particles can be included by 10 to 50% by weight of a total solid content of a composition. When it is 10% by weight or more, a function given by the metal oxide particles can be added to a coating film and surface hardness of the coating film can be improved, while when 50% by weight or less, a decrease of surface hardness of a coating film can be prevented more.

Since metal oxide particles as such form firm aggregate of primary particles, to disintegrate for re-dispersing the aggregate to be primary particles, an ultrasound, homogenizer, omni-mixer, bead mill, jet mill, and other well-known means may be used.

Next, a polyfunctional (meth)acrylate having a multi-branched structure serves as a dispersant for bonding an ionizing radiation curable resin and metal oxide particles. As a result that a multi-branched polyfunctional (meth)acrylate is absorbed on a hydroxyl group on metal oxide particle surfaces and covers the metal oxide particles, aggregate of metal oxide particles can be prevented. For that purpose, a polyfunctional (meth)acrylate having a multi-branched structure can have a group easily absorbed on a hydroxyl group existing on a surface modification phase of a carboxyl group, amino group, carbonyl group, acrylic group and methacryl group, etc. so as to be easily absorbed on the metal oxide particles.

By using a polyfunctional (meth)acrylate having a multi-branched structure as a dispersant as explained above, polymerization of an ionizing radiation curable resin is not hindered and a density of an acrylic group on metal oxide particle surfaces can be high. Also, by using a polyfunctional (meth)acrylate having a multi-branched structure, compatibility of an ionizing radiation curable resin and metal oxide particles is enhanced and the ionizing radiation curable resin is mixed with the metal oxide particles while maintaining the degree of dispersion.

Furthermore, by using a polyfunctional (meth)acrylate having a multi-branched structure as a dispersant, it is possible to prevent a decrease of surface hardness of a coating film comprising metal oxide particles and an ionizing radiation curable resin and to improve surface hardness. The reason why the surface hardness is not decreased is considered that, as well as the effect of improving the surface hardness as a result of adding metal oxide particles, a polyfunctional (meth)acrylate having a multi-branched structure brings a gradient functionality between metal oxide particles and an ionizing radiation curable resin and a curing shrinkage difference can be reduced, consequently, a decrease of surface hardness caused by fine cracks between interfaces of metal oxide particles and a polyfunctional (meth)acrylate having a multi-branched structure does not occur.

It is also considered that, as a result that a multi-branched polyfunctional (meth)acrylate absorbed on the metal oxide particle surfaces can be brought to chemically bonded between an ionizing radiation curable resin and an acryloil group at the terminal, the multi-branched polyfunctional (meth)acrylate itself released from the metal oxide particle surfaces can be polymerized, consequently, polymerization of the ionizing radiation curable resin is not hindered and a crosslink density is not lowered.

On the other hand, when an ionizing radiation curable resin is mixed with a linear polyfunctional (meth)acrylate as a dispersant, because a linear polyfunctional (meth)acrylate is liable to cause curing shrinkage, a curing shrinkage difference arises between metal oxide particles and linear polyfunctional (meth)acrylate, and fine cracks arise between interfaces of metal oxide particles and linear polyfunctional (meth)acrylate. As a result, it is considered that the surface hardness cannot be improved because of an interaction of the effect of improving surface hardness by adding metal oxide particles and a decrease of surface hardness caused by fine cracks.

As a polyfunctional (meth)acrylate having a multi-branched structure as explained above, those having chemical bond of a three-dimensional structure at the main chain, wherein a monomer polymerizes while branching, and having a positive branch structure in a spread radial shape, such as a dendrimer structure, hyper-branch structure, star-polymer structure and a comb-like structure, may be used. Those having a dendrimer structure, hyper-branch structure and star-polymer structure having a number of branch structures are possible.

Specifically, those having a functional group, such as an amino group, hydroxyl group, carboxyl group, phenyl group, ethylene oxide group, vinyl group and propylene oxide group, and having a (meth)acrylate functional group at the terminal. Among them, those including an ethylene oxide group and having a (meth)acrylate functional group at the terminal can be beneficial in terms of solubility in a solvent, handleability and compatibility with an ionizing radiation curable resin, etc.

The number of (meth)acrylate functional groups of a multi-branched polyfunctional (meth)acrylate can be 3 to 10 and possibly 5 to 8 in terms of increasing bond with an ionizing radiation curable resin. Also, a weight-average molecular weight of a multi-branched polyfunctional (meth)acrylate varies depending on a median diameter of metal oxide particles in the composition and should not be flatly said, but those in a range of 500 to 30000 may be used and, when using metal oxide particles having a median diameter of 300 nm or smaller, those in a range of 500 to 3000 are beneficial, and 1000 to 3000 can be more beneficial to obtain dispersion stability.

A polyfunctional (meth)acrylate having a multi-branched structure can be included by an amount of 5 to 20% by weight of a total solid content of the composition. When it is 5% by weight or more, surface hardness of a coating film can be improved. A polyfunctional (meth)acrylate having a multi-branched structure exhibits small curing shrinkage and hardly causes cracks, etc. on the coating film, however, surface hardness of the coating film cannot be obtained only with a polyfunctional (meth)acrylate having a multi-branched structure. Therefore, by setting to 20% by weight or less, a decrease of surface hardness of the coating film can be prevented.

Such a multi-branched polyfunctional (meth)acrylate exhibits high compatibility, which is different from a linear polyfunctional (meth)acrylate. Therefore, compatibility of metal oxide particles themselves can be enhanced by modifying the metal oxide particle surfaces by such a multi-branched polyfunctional (meth)acrylate. As a result, even in the state where metal oxide particles are at high concentration, it is possible to produce a composition with less solvent shock than that in the case of using a linear polyfunctional (meth)acrylate dispersant.

Also, when using a multi-branched polyfunctional (meth)acrylate as a dispersant, a dispersion having low viscosity can be obtained comparing with that in the case of a linear polyfunctional (meth)acrylate, so that it is possible for nano-level dispersion using fine beads.

A composition comprising an ionizing radiation curable resin, metal oxide particles and a polyfunctional (meth)acrylate having a multi-branched structure as explained above may be also obtained by adding an ionizing radiation curable resin after dispersing metal oxide particles and a multi-branched polyfunctional (meth)acrylate in an appropriate dispersion medium. It is also possible to use an ionizing radiation curable resin as a dispersion medium.

The composition according to an embodiment of the presently disclosed subject matter may be dissolved in a solvent, etc. to form an application liquid, applied by a well-known coating method, dried and cured so as to form a coating film.

An embodiment of a laminate of the presently disclosed subject matter will be explained. The laminate can be a substrate provided with a coating film formed by a composition comprising an ionizing radiation curable resin, metal oxide particles and a polyfunctional (meth)acrylate having a multi-branched structure.

As a substrate, a molding formed by a synthetic resin, such as polyester, ABS (acrylonitrile-butadiene-styrene), polystyrene, polycarbonate, acryl, polyolefin, cellulose resin, polysulphone, polyphenylene sulphide, polyether sulphone, polyetherether ketone and polyimide, may be used and those in a various shapes may be used. Among them, those having excellent flatness in a film shape and sheet shape can be used, and a polyester film processed by uniaxial-stretched or biaxially-stretched can provide excellent mechanical strength, dimension stability and, furthermore, stronger stiffness.

A thickness of a sheet-shaped or film-shaped molding as such can be 6 to 250 μm. Since curls due to coating film shrinkage hardly arise on a coating film formed by a composition of the presently disclosed subject matter, it is also applicable to a thin substrate, for example, having a thickness of 3 to 20 μm.

As such a substrate, let alone transparent ones, opaque moldings, such as a foamed sheet and a sheet comprising carbon black or other black colorant and other colorant, may be used, as well.

By dissolving the composition explained above in a solvent, etc. properly to obtain an application liquid, applying the same to a substrate as explained above, drying and irradiating an ionic radiation for curing to form a coating film, a coating film with high surface hardness is formed and surface hardness of the substrate is improved, furthermore, a new function is added by the metal oxide particles. For example, when using a zinc oxide as metal oxide particles, an ultraviolet ray blocking function is given to the coating film; when using a silicon oxide, birefringence of the coating film is reduced and a highly transparent coating film can be obtained; and when using a titanium oxide, an ultraviolet ray blocking function is given and a coating film with a high refractive index can be obtained.

A thickness of a coating film as above can be 3 to 20 μm and possibly 4 to 15 μm. When it is 3 μm or thicker, surface hardness of the coating film can be improved and, when 20 μm or thinner, a decline of transparency can be prevented.

By forming a laminate as explained above, surface hardness of a substrate surface can be improved and a function can be newly added to the laminate by metal oxide particles.

### EXAMPLES

Below, the presently disclosed subject matter will be explained furthermore by using examples. Note that “part” and “%” are based on weight unless otherwise mentioned.

### Example 1

Propylene glycol monomethyl ether in an amount of 15.32 g was added with aggregate of a zirconium oxide (PCS: Nippon Denko Co., Ltd., specific surface area of 33.6 m²/g, specific surface area diameter of 29.5 nm) in an amount of 7.59 g and a multi-branched polyfunctional acrylate having a dendrimer structure (V#1020: OSAKA ORGANIC CHEMICAL INDUSTRY LTD, molecular weight of 1000 to 3000) in an amount of 5.00 g and agitated for about one hour at the room temperature.

The premix liquid above was subjected to disintegration and dispersion treatments by a bead mill dispersing machine using zirconia beads having a particle diameter of 0.3 mm to 0.05 mm with a residence time of 120 minutes, so that a zirconium oxide dispersion liquid of an example 1 was obtained. A median diameter of zirconium oxide particles was 40 nm in the zirconium oxide dispersion liquid.

The zirconium oxide dispersion liquid of the example 1 in an amount of 5 g was added with propylene glycol monomethyl ether in an amount of 5 g and an ionizing radiation curable resin (BEAMSET 575: Arakawa Chemical Industries, Ltd., solid content 100%, (meth)acrylate-type oligomer) in an amount of 4.16 g and an initiator (IRGACURE 184: Ciba Japan KK) in an amount of 0.448 g, so that a composition of the example 1 was obtained.

After applying the composition of the example 1 to a 50 μm-polyester film (COSMOSHINE A4300: TOYOBO CO., LTD.) and drying, an ultraviolet ray was irradiated for 10 seconds (1000 mJ/cm²) to form a coating film having a thickness of about 10 μm, so that a laminate of the example 1 was produced.

### Example 2

Other than changing the zirconium oxide used in the example 1 to a zirconium oxide (HP: Nippon Denko Co., Ltd., specific surface area of 1.2 m²/g, specific surface area diameter of 831 nm) in an amount of 7.59 g and changing the multi-branched polyfunctional acrylate to a multi-branched polyfunctional acrylate having a star-polymer structure (STAR-501: OSAKA ORGANIC CHEMICAL INDUSTRY LTD, molecular weight of 15000 to 21000), a composition of an example 2 was obtained in the same way as in the example 1.

Furthermore, other than using the composition of the example 2 and forming a coating film having a thickness of about 15 μm, a laminate of the example 2 was produced in the same way as in the example 1. A median diameter of zirconium oxide particles was fpm in a zirconium oxide dispersion liquid.

### Example 3

Other than changing the ionizing radiation curable resin (BEAMSET 575: Arakawa Chemical Industries, Ltd., solid content 100%, a (meth)acrylate-type oligomer) in an amount of 4.16 g used in the example 1 to an ionizing radiation curable resin (BEAMSET 575: Arakawa Chemical Industries, Ltd.) in an amount of 3.87 g and an ionizing radiation curable resin (PEMP: SC Organic Chemical Co., Ltd., a polythiol monomer) in an amount of 0.29 g, a composition of an example 3 was obtained in the same way as in the example 1.

After applying the composition of the example 3 to a 50 μm-polyester film (COSMOSHINE A4300: TOYOBO CO., LTD.) and drying, an ultraviolet ray was irradiated for 10 seconds (1000 mJ/cm²) to form a coating film having a thickness of about 10 μm, so that a laminate of the example 3 was produced.

### Comparative Example 1

Propylene glycol monomethyl ether in an amount of 5 g was added with an ionizing radiation curable resin (BEAMSET 575: Arakawa Chemical Industries, Ltd., solid content 100%) in an amount of 4.16 g, a multi-branched polyfunctional acrylate having a dendrimer structure (V#1020: OSAKA ORGANIC CHEMICAL INDUSTRY LTD, molecular weight of 1000 to 3000) in an amount of 5.00 g and an initiator (IRGACURE 184: Ciba Japan KK) in an amount of 0.448 g, and a composition of a comparative example 1 was obtained.

After applying the composition of the comparative example 1 to a 50 μm-polyester film (COSMOSHINE A4300: TOYOBO CO., LTD.) and drying, an ultraviolet ray was irradiated for 10 seconds (1000 mJ/cm²) to form a coating film having a thickness of about 10 μm, so that a laminate of the comparative example 1 was produced.

### Comparative Example 2

Propylene glycol monomethyl ether in an amount of 15.32 g was added with aggregate of a zirconium oxide (PCS: Nippon Denko Co., Ltd., specific surface area of 33.6 m²/g, specific surface area diameter of 29.5 nm) in an amount of 7.59 g and agitated for about one hour at the room temperature.

The premix liquid above was subjected to disintegration and dispersion treatments by a bead mill dispersing machine using zirconia beads having a particle diameter of 0.3 mm to 0.05 mm with a residence time of 120 minutes, so that a zirconium oxide dispersion liquid of comparative example 2 was obtained. A median diameter of zirconium oxide particles was 510 nm in the zirconium oxide dispersion liquid.

The zirconium oxide dispersion liquid of the comparative example 2 in an amount of 5 g was added with propylene glycol monomethyl ether in an amount of 5 g, an ionizing radiation curable resin (BEAMSET 575: Arakawa Chemical Industries, Ltd., solid content 100%) in an amount of 4.16 g and an initiator (IRGACURE 184: Ciba Japan KK) in an amount of 0.448 g, so that a composition of the comparative example 2 was obtained.

After applying the composition of the comparative example 2 to a 50 μm-polyester film (COSMOSHINE A4300: TOYOBO CO., LTD.) and drying, an ultraviolet ray was irradiated for 10 seconds (1000 mJ/cm²) to form a coating film having a thickness of about 10 μm, so that a laminate of the comparative example 2 was produced.

### Comparative Example 3

Propylene glycol monomethyl ether in an amount of 15.32 g was added with aggregate of a zirconium oxide (PCS: Nippon Denko Co., Ltd., specific surface area of 33.6 m²/g, specific surface area diameter of 29.5 nm) in an amount of 7.59 g and a linear polyfunctional acrylate (NK Ester A-DPH: Shin-Nakamura Chemical Co., Ltd., molecular weight of 626) in an amount of 5.00 g and agitated for about one hour at the room temperature.

The premix liquid as above was subjected to disintegration and dispersion treatments by a bead mill dispersing machine using zirconia beads having a particle diameter of 0.3 mm to 0.05 mm with a residence time of 120 minutes, so that a zirconium oxide dispersion liquid of a comparative example 3 was obtained. A median diameter of zirconium oxide particles was 42 nm in the zirconium oxide dispersion liquid.

The zirconium oxide dispersion liquid of the comparative example 3 in an amount of 5 g was added with propylene glycol monomethyl ether in an amount of 5 g, an ionizing radiation curable resin (BEAMSET 575: Arakawa Chemical Industries, Ltd., solid content 100%) in an amount of 4.16 g and an initiator (IRGACURE 184: Ciba Japan KK) in an amount of 0.448 g, so that a composition of the comparative example 3 was obtained.

After applying the composition of the comparative example 3 to a 50 μm-polyester film (COSMOSHINE A4300: TOYOBO CO., LTD.) and drying, an ultraviolet ray was irradiated for 10 seconds (1000 mJ/cm²) to form a coating film having a thickness of about 10 μm, so that a laminate of the comparative example 3 was produced.

### Reference Example

Propylene glycol monomethyl ether in an amount of 5 g was added with an ionizing radiation curable resin (BEAMSET 575: Arakawa Chemical Industries, Ltd., solid content 100%) in an amount of 4.16 g and an initiator (IRGACURE 184: Ciba Japan KK) in an amount of 0.448 g, so that a composition of a reference example was obtained.

After applying the composition of the reference example to a 50 μm-polyester film (COSMOSHINE A4300: TOYOBO CO., LTD.) and drying, an ultraviolet ray was irradiated for 10 seconds (1000 mJ/cm²) to form a coating film having a thickness of about 10 μm, so that a laminate of the reference example was produced.

The laminates obtained in the examples 1 to 3, comparative examples 1 to 3 and reference example were evaluated as to following items. The results are shown in Table 1.

### [Surface Hardness]

According to JIS K5600-5-4:1999, pencil hardness of a coating film surface was measured on the laminates of the examples 1 to 3, comparative examples 1 to 3 and reference example. The results are shown in Table 1.

### [Transparency (Total Light Transmittivity) Evaluation]

Based on JIS-K7361-1:2000, a total light transmittivity was measured by using a haze meter (NDH2000: NIPPON DENSHOKU INDUSTRIES Co., Ltd.). Those exhibited the total light transmittivity of 90% or higher were marked “o”, those having 80% or higher but lower than 90% were “Δ” and those lower than 80% were “x”. Note that a light was irradiated on the surface having a coating film. The results are shown in Table 1.

TABLE 1

| | Surface Hardness | Transparency |
|---|---|---|
| Example 1 | 3H | ∘ |
| Example 2 | 3H | Δ |
| Example 3 | 3H | ∘ |
| Comparative Example 1 | 2H | ∘ |
| Comparative Example 2 | H | x |
| Comparative Example 3 | 2H | ∘ |
| Reference Example | 2H | ∘ |

In the laminates of the examples 1 to 3, a multi-branched polyfunctional acrylate absorbed on the zirconium oxide surfaces was chemically bonded between an ionizing radiation curable resin and an acryloil group at the terminal so as to attain bonding between the a zirconium oxide and ionizing radiation curable resin, and polymerization of the ionizing radiation curable resin was not hindered, therefore, pencil hardness was not decreased comparing with that in the case with only an ionizing radiation curable resin of the reference example.

Also, a multi-branched polyfunctional acrylate was present between the metal oxide particles and ionizing radiation curable resin and a curing shrinkage difference between the two could be reduced, consequently, a decrease of the surface hardness due to fine cracks on the metal oxide particle interfaces did not occur and an effect of improving the surface hardness brought by adding the zirconium oxide was obtained, so that surface hardness of the coating film was improved.

Also, in the laminates of the examples 1 and 3, the effect of improving the refractive index brought by a zirconium oxide was obtained and, furthermore, a median diameter of 40 nm was attained in the zirconium oxide in a dispersion liquid, consequently, scattering lights by the zirconium oxide in the coating film was able to be decreased and the laminates came to have very excellent transparency.

The laminate of the example 2 could obtain the effect of improving the refractive index from a zirconium oxide. However, because a median diameter of the zirconium oxide in a dispersion liquid was 1 μm, scattering lights by the zirconium oxide could not be decreased and the transparency was a little inferior.

The laminate of the example 3 comprised a polythiol monomer as an ionizing radiation curable resin, so that scratch resistance to steel wool was improved and the flexibility was also improved comparing with those of the laminate of the example 1.

The laminate of the comparative example 1 did not have any zirconium oxide existed therein. Because bond was attained between the ionizing radiation curable resin and multi-branched polyfunctional acrylate and polymerization of the ionizing radiation curable resin was not hindered, surface hardness was not decreased comparing with that in the case only with an ionizing radiation curable resin of the reference example. However, because a zirconium oxide was not added, the laminate could not obtain the effect of improving a refractive index and the effect of improving surface hardness from a zirconium oxide.

The laminate of the comparative example 2 did not comprise any polyfunctional acrylate to be absorbed on zirconium oxide surfaces, and compatibility between a zirconium oxide and an ionizing radiation curable resin could not be obtained. Also, a curing shrinkage difference between the zirconium oxide and ionizing radiation curable resin was large and fine cracks arose on the zirconium oxide interfaces, as a result, the surface hardness was significantly decreased comparing with that in the case of comprising only an ionizing radiation curable resin of the reference example. Also, because compatibility between the zirconium oxide and ionizing radiation curable resin was poor, the transparency was also poor.

In the laminate of the comparative example 3, not a multi-branched polyfunctional acrylate but a linear polyfunctional acrylate was used as a dispersant. Because chemical bonding was brought between the ionizing radiation curable resin and an acryloil group at the terminal and polymerization of the ionizing radiation curable resin was not hindered, surface hardness was not decreased when compared to that in the case of only comprising an ionizing radiation curable resin of the reference example.

However, because a curing shrinkage difference arose between metal oxide particles and a linear polyfunctional acrylate and fine cracks arose between metal oxide particle interfaces and the linear polyfunctional acrylate, an interaction between the effect of improving surface hardness by adding metal oxide particles and a decrease of surface hardness due to the fine cracks, the surface hardness of the coating film could not be improved.

Also, in the zirconium oxide dispersion liquid of the example 1, a zirconium oxide had a specific surface area diameter of 29.5 nm and a multi-branched polyfunctional acrylate having a molecular weight of 1000 to 3000 was used, therefore, a median diameter of 40 nm was attained. Also, the dispersion liquid after one week exhibited storage stability.

In the zirconium oxide dispersion liquid of the example 2, a zirconium oxide had a specific surface area diameter of 831 nm and a multi-branched polyfunctional acrylate having a molecular weight of 15000 to 21000 was used as a multi-branched polyfunctional acrylate, therefore, a median diameter of 1 μm was attained. However, because a particle diameter of the zirconium oxide was large, deposition was observed in the dispersion liquid after one week. The dispersion liquid was restored to a dispersion state when re-dispersed.

The zirconium oxide dispersion liquid of the comparative example 2 was dispersed without using any multi-branched polyfunctional acrylate. Because it did not comprise what serves as a dispersant, gel and aggregate were observed in the dispersion liquid after one week, and storage stability was not obtained.

1. A composition comprising
an ionizing radiation curable resin,
metal oxide particles and
a polyfunctional (meth)acrylate having a multi-branched structure.

2. The composition according to claim 1, wherein the polyfunctional (meth)acrylate having a multi-branched structure has a carboxyl group, amino group, carbonyl group, and acrylic group or methacrylic group.

3. The composition according to claim 1, wherein the polyfunctional (meth)acrylate having a multi-branched structure has a dendrimer structure, hyper-branch structure or star-polymer structure, each having a number of branch structures.

4. The composition according to claim 3, wherein the polyfunctional (meth)acrylate having a multi-branched structure includes an ethylene oxide group and has a (meth)acrylate-functional group at the terminal.

5. The composition according to claim 1, wherein the number of (meth)acrylate functional-groups of the polyfunctional (meth)acrylate having a multi-branched structure is 3 to 10.

6. The composition according to claim 1, wherein the polyfunctional (meth)acrylate having a multi-branched structure has weight-average molecular weight of 500 to 30000.

7. The composition according to claim 1, wherein the polyfunctional (meth)acrylate having a multi-branched structure is included by an amount of 5 to 20% by weight of a total solid content of the composition.

8. The composition according to claim 1, wherein the ionizing radiation curable resin includes at least one of linear (meth)acrylate oligomers, (meth)acrylic-type monomers and polythiol monomers.

9. The composition according to claim 1, wherein the ionizing radiation curable resin is included by an amount of 40 to 80% by weight of a total solid content of the composition.

10. The composition according to claim 1, wherein the metal oxide particles has a median diameter of 5 nm to 15 μm in a dispersion liquid measured by a dynamic scattering method.

11. The composition according to claim 1, wherein the metal oxide particles are included by an amount of 10 to 50% by weight of a total solid content of the composition.

12. A laminate provided with a coating film formed on a substrate by a composition comprising an ionizing radiation curable resin, metal oxide particles and a polyfunctional (meth)acrylate having a multi-branched structure.

13. The laminate according to claim 12, wherein the coating film is formed to have a thickness of 3 to 20 μm.

14. The composition according to claim 2, wherein the polyfunctional (meth)acrylate having a multi-branched structure has a dendrimer structure, hyper-branch structure or star-polymer structure, each having a number of branch structures.

15. The composition according to claim 14, wherein the polyfunctional (meth)acrylate having a multi-branched structure includes an ethylene oxide group and has a (meth)acrylate-functional group at the terminal.

16. The composition according to claim 2, wherein the number of (meth)acrylate functional-groups of the polyfunctional (meth)acrylate having a multi-branched structure is 3 to 10.

17. The composition according to claim 3, wherein the number of (meth)acrylate functional-groups of the polyfunctional (meth)acrylate having a multi-branched structure is 3 to 10.

18. The composition according to claim 4, wherein the number of (meth)acrylate functional-groups of the polyfunctional (meth)acrylate having a multi-branched structure is 3 to 10.

19. The composition according to claim 14, wherein the number of (meth)acrylate functional-groups of the polyfunctional (meth)acrylate having a multi-branched structure is 3 to 10.

20. The composition according to claim 2, wherein the polyfunctional (meth)acrylate having a multi-branched structure has weight-average molecular weight of 500 to 30000.
